(19) United States
(12) Patent Application Publication
(10) Pub. No.: US 2007/0015401 A1
(43) Pub. Date: Jan. 18, 2007

(54) COMPOUND UNIVERSAL SERIAL BUS CONNECTOR

(76) Inventor: Zheng-Heng Sun, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,493

(22) Filed: Dec. 29, 2005

(30) Foreign Application Priority Data
Jul. 15, 2005 (CN) 200520061652.2

(51) Int. Cl. H01R 13/60

(52) U.S. Cl. 439/540.1

(57) ABSTRACT

A compound Universal Serial Bus (USB) connector includes a main body, a first plug, a second plug and a first cable. The first plug formed in the main body comprising a VCC pin and a GND pin. The second plug formed in the main body comprising a VCC pin and a GND pin. The VCC and GND pins of the second plug being connected to the VCC and GND pins of the first plug. The first cable is linked to the main body and connected to the VCC and GND pins of the first plug.

### FIELD OF THE INVENTION

The present invention relates to an improved Universal Serial Bus connector, and particularly to a compound Universal Serial Bus connector.

### DESCRIPTION OF RELATED ART

To facilitate the linking of various external peripheral devices with different system terminals, four major international companies (including Compaq, Intel, Microsoft and NEC) have developed the Universal Serial Bus (USB) interface in 1998. Ever since the Microsoft Windows 98 operating system started to provide built-in program for driving USB interface peripheral devices, the use of these peripheral products is facilitated. As a result, the applications of USB products have been expanding gradually.

An USB interface can provide current of 500 milliamperes and voltage of 5 volts, and the providing power is 2.5 wattages. In the past, a USB connector could be linking only one USB port, and a higher-power USB device can not be working normally.

What is needed is a compound USB connector that can link two USB ports, and provide higher power.

### SUMMARY OF INVENTION

An exemplary compound USB connector includes a main body, a first plug, a first cable and a second plug. The first plug and the second plug are formed in the main body. The first plug includes a VCC pin and a GND pin, so does the second plug. The VCC and GND pins of the first plug are connected to the VCC and GND pins of the second plug respectively. The first cable is linked to the main body and connected to the first plug.

It is simple and economical to use the compound USB connector to link two USB ports to provide higher power for a higher-power USB device.

Other advantages and novel features will become more apparent from the following detailed description when taken in conjunction with the accompanying drawings, in which:

### BRIEF DESCRIPTION OF DRAWINGS

FIG. 1 is an isometric view of a compound USB connector in accordance with a first preferred embodiment of the present invention;

FIG. 2 is an isometric view of a compound USB connector in accordance with a second preferred embodiment of the present invention; and

FIG. 3 is an isometric view showing the inside structure of the compound USB connector of FIG. 2.

### DETAILED DESCRIPTION

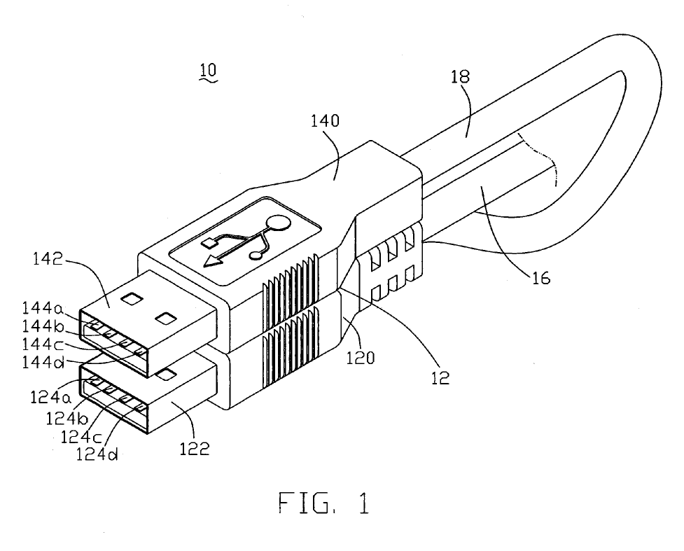

FIG. 1 is an isometric view showing the structure of a compound USB connector 10 according to one preferred embodiment of the present invention. As illustrated in FIG. 1, the compound USB connector 10 includes a main body 12 and a first cable 16. The main body 12 includes a first module 120 and a second module 140. A first plug 122 forms the first module 120. A second plug 142 forms the second module 140. The first cable 16 is inked to the first module 120 and connected to the first plug 122.

The first plug 122 includes four pins 124a, 124b, 124c and 124d. The second plug 142 includes four pins 144a, 144b, 144c and 144d. The pins 124a and 144a are VCC pins. The pins 124d and 144d are GND pins. The signals that the pins transmit are shown in the following table:

| PIN | SIGNAL |
|---|---|
| a | VCC(+5 V) |
| b | D− |
| c | D+ |
| d | Ground |

The compound USB connector 10 further includes a second cable 18. The VCC pin 124a and the GND pin 124d of the first plug 122 are connected to the VCC pin 144a and GND pin 144d of the second plug 142 respectively through the second cable 18.

When the compound USB connector 10 is connected to a computer, the first plug 122 and the second plug 142 are connected to two USB ports of the computer to transmit as twice current as a conventional USB connector.

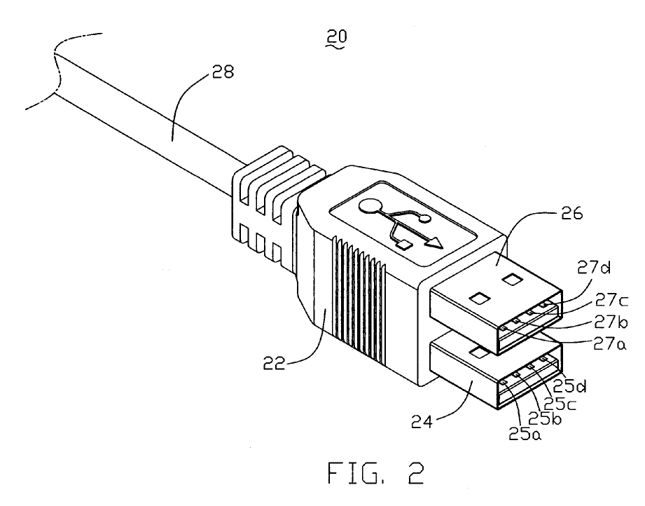

FIG. 2 is an isometric view showing the structure of a compound USB connector according to a second preferred embodiment of the present invention. As illustrated in FIG. 2, the compound USB connector 20 includes an integral main body 22 and a cable 28. The integral main body 22 includes a first plug 24 and a second plug 26. The cable 28 is linked to the integral main body 22 and connected to the first plug 24.

The first plug 24 includes four pins 25a, 25b, 25c and 25d. The second plug 26 includes four pins 27a, 27b, 27c and 27d. The pins 25a and 27a are VCC pins. The pins 25d and 27d are GND pins. The signals that the pins transmit are shown in the table.

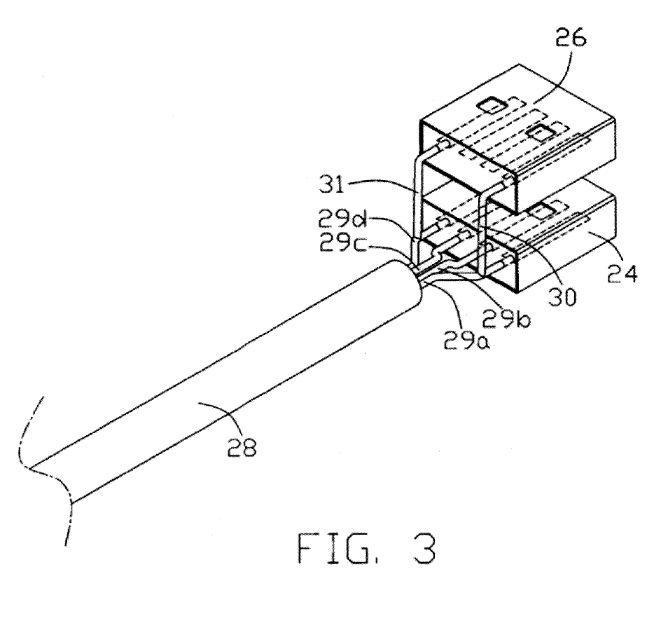

FIG. 3 is an isometric view showing the inside structure of the compound USB connector of FIG. 2. As illustrated in FIG. 2 and FIG. 3, the cable 28 includes four leads 29a, 29b, 29c and 29d. The leads 29a, 29b, 29c and 29d are connected to the 25a, 25b, 25c and 25d pins of the first plug 24 respectively. The VCC pin 29a of the second plug 26 is connected to the lead 29a through a lead 30. The GND pin 27d of the second plug 26 is connected to the lead 29d through a lead 31.

The VCC pin 25a of the first plug 24 is connected to the VCC pin 27a of the second plug 26 through the lead 30. The GND pin 25d of the first plug 24 is connected to the GND pin 27d of the second plug 26 through the lead 31. As the result, the compound USB connector 20 can provide twice of the current of a conventional USB connector when it is working.

The compound USB connectors in accordance with the first and second preferred embodiments can provide twice of the current of a conventional USB connector. Thus, a higher-power USB device can work in working order through this kind of connector.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A compound Universal Serial Bus (USB) connector comprising:
a main body;
a first plug formed in the main body, and comprising a VCC pin and a GND pin;
a second plug formed in the main body, and comprising a VCC pin and a GND pin, the VCC and GND pins of the second plug being electrically connected to the VCC and GND pins of the first plug respectively; and
a first cable having an end connected to the VCC and GND pins of the first plugs and another end configured for connection with a USB device.

2. The compound Universal Serial Bus (USB) connector as claimed in claim 1, wherein the main body comprises:
a first module which the first plug is set in;
a second module which the second plug is set in; and
a second cable connecting the first plug to the second plug.

3. The compound Universal Serial Bus (USB) connector as claimed in claim 2, wherein the VCC and GND pins of the first plug are respectively connected to the VCC and GND pins of the second plug via the second cable.

4. The compound Universal Serial Bus (USB) connector as claimed in claim 1, wherein the main body is integral, said first plug and second plug are set in the integral main body.

5. The compound Universal Serial Bus (USB) connector as claimed in claim 4, wherein the VCC and GND pins of the first plug are respectively connected to the VCC and GND pins of the second plug via two leads.

6. (canceled)

7. A compound Universal Serial Bus (USB) connector comprising:
a main body;
two spaced plugs formed from the main body and configured for being inserted into two USB ports of an electronic apparatus; and
a cable extending out from the main body and electrically connected to the two plugs so that the two plugs are capable of being electrically connected between the electronic apparatus and the cable in parallel to allow the USB connector to provide twice of a current of only one plug.

8. The USB connector as claimed in claim 7, wherein each of the plugs comprises a plurality of pins, at least one of the pins of each plug being electrically connected to the cable.

9. The USB connector as claimed in claim 8, wherein the at least one of the pins of one of the plugs is electrically connected to the cable via at least one lead which is located within the main body.

10. The USB connector as claimed in claim 8, wherein the at least one of the pins of one of the plugs is electrically connected to the at least one of the pins of the other of the plugs via an additional cable which is located outside of the main body.
